(19) United States
(12) Patent Application Publication
(10) Pub. No.: US 2005/0108324 A1
(43) Pub. Date: May 19, 2005

(54) Serialized inventory control system and method

(76) Inventors: David Stritzinger, Miami, FL (US); Joseph Jordan Constabileo, Gurnee, IL (US)

Correspondence Address: KIRKPATRICK & LOCKHART NICHOLSON GRAHAM LLP, 535 SMITHFIELD STREET, PITTSBURGH, PA, 15222, US

(21) Appl. No.: 10/696,965

(22) Filed: Oct. 30, 2003

(51) Int. Cl. G06F 15/16

(52) U.S. Cl. 709/203

(57) ABSTRACT

Systems and techniques for tracking inventory include a serialized inventory control system configured to receive serialized information, apply validation rules to the serialized information, flag exceptions to the validation rules, and report the exceptions. The serialized inventory control system includes database logic to check that that serialized information does not exist for an entering inventory item and that serialized information does exist for an exiting inventory item.

### TECHNICAL FIELD

The present invention relates generally to systems and techniques for tracking entities and, more particularly, to a system and method for tracking serial numbers or other discreet items.

### BACKGROUND

In a product distribution environment, it is common for a company to track the movement and status of inventory. For effective inventory control, a company generally must have the ability to collect inventory information for each item, review the current state of an item in its life cycle, issue and track the status of purchase orders and work orders, monitor production and distribution, and provide stock adjustments. The accuracy and availability of such inventory information is vital as carriers, customers, operations and various areas of the company typically rely on such information for reporting purposes, as well as to make important short-term and long-term business decisions.

Enterprise Resource Planning (ERP) systems have been developed in an attempt to integrate, manage, and analyze information for companies. In general, an ERP system may further inventory control by providing on-line and/or real-time information, standardization of data, analysis, and reporting capabilities that can be used by a company to realize efficiencies and optimize operations. In some cases, the ERP system may gather data from a various sources such as manufacturers, distributors, suppliers, and customers and use such information for financial planning, accounting, allocation of human resources, marketing, and/or manufacturing.

ERP systems typically are implemented as off-the-shelf software packages installed on database platforms (e.g., Oracle, MS SQL Server, SQLBase, Sybase, SAP, DB2/400, DB2/MVS, DB2/Unix, Informix). While existing ERP systems may be offered with different suites of features and may allow some degree of customization, in many cases, such ERP systems are inadequate to meet the exacting requirements of particular industries.

In the telecommunications industry, for instance, a vast amount of information is associated with the distribution of subscriber equipment. In particular, a wireless telephone handset may be associated with serialized information such as an Electronic Serial Number (ESN)—i.e. a unique identification number embedded on a microchip in the handset the manufacturer. Typically, the ESN is transmitted when a call is placed and electronically checked in order to prevent fraudulent use of the handset. Other serialized information such as, for example, an International Mobile Equipment Identification (IMEI), a mobile identification number (MIN), one or more unlocking codes for the handset, one or more Subscriber Information Module (SIM) card codes, also may be associated with the handset. Moreover, a finished handset assembly may be made up of various basic components (e.g., speakers, microphones, keypads, displays, ringers, processors, chipsets, memories, displays, batteries) and add-on components (e.g., communication devices, cameras, location technologies, multimedia players), each associated with its own serialized information.

Managing any significant volume of inventory in the telecommunications industry thus requires dealing with exponential growth in the management of the serialized information. ERP systems, however, do not provide the scalability necessary to effectively manage and coordinate the millions of serialized transactions handled by distributors each month. Namely, due to the size and growth of the transaction volume, the back-end architecture of existing ERP systems cannot support tracking serialized information such as ESNs.

Accordingly, there exists the need for systems and methods for exactly tracking a high number of serialized items in the telecommunications industry and in other environments.

### SUMMARY

In one general aspect, systems and techniques for tracking inventory include a serialized inventory control system configured to receive serialized information, apply validation rules to the serialized information, flag exceptions to the validation rules, and report the exceptions. The serialized inventory control system includes database logic to check that that serialized information does not exist for an entering inventory item and that serialized information does exist for an exiting inventory item.

Aspects of the present invention may be implemented by an apparatus and/or by a computer program stored on a computer readable medium. The computer readable medium may comprise a disk, a client device, a network device, a host device, and/or a propagated signal.

Other features and advantages will be apparent from the following description, including the drawings, and from the claims.

### DESCRIPTION OF THE FIGURES

FIG. 1 illustrates one embodiment of a communications system according to the present invention.

FIG. 2 illustrates one embodiment of a communications system according to the present invention.

FIG. 3 illustrates one embodiment of a communications system according to the present invention.

FIG. 4 is a flowchart of one embodiment of a method according to the present invention.

### DETAILED DESCRIPTION

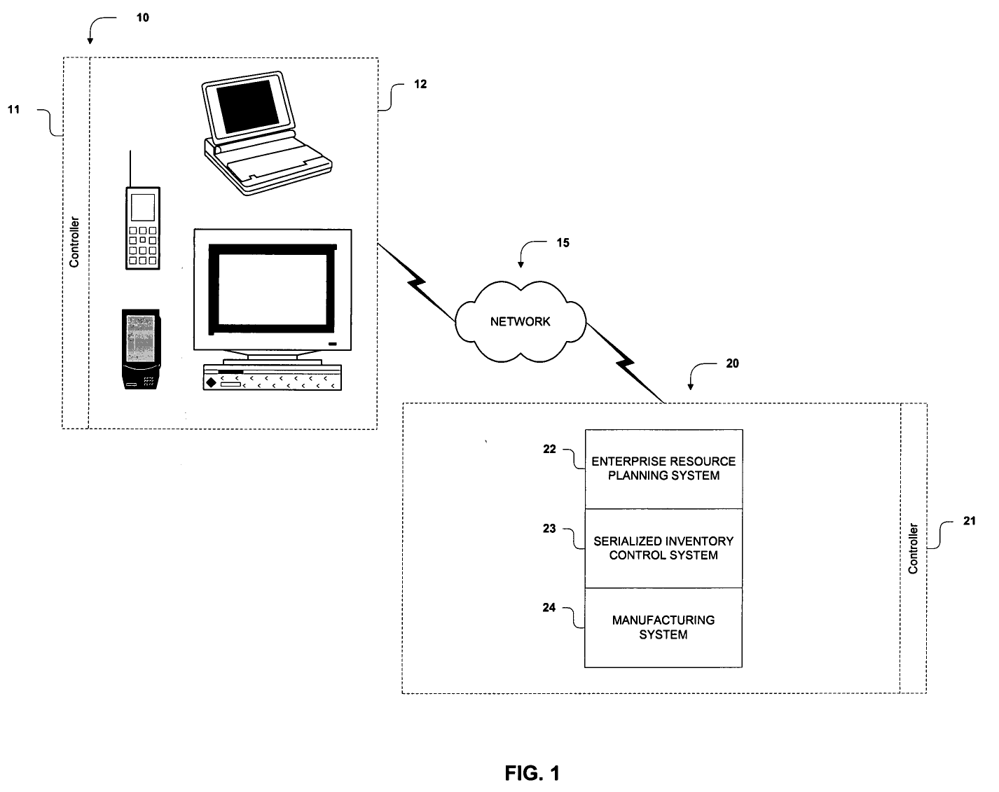

FIG. 1 illustrates one embodiment of an exemplary communications system for automatically presenting a visual representation depicting a relationship between entities involved in a commercial deal. For brevity, several elements in figure are represented as monolithic structures. It is to be understood, however, that each structure may include numerous interconnected computing elements and/or components designed to operate according to aspects of the present invention.

As shown, the communications system includes a client system 10 connected through a network 15 to a host system 20. The client system 10 and the host system 20 are configured to communicate and exchange information through the network 15. The host system 20 may include and/or form part of an information delivery network, such as, for example, the Internet, the World Wide Web (Web), an on-line service provider, a private network, and/or any other analog or digital wired and/or wireless network that provides information.

In general, the client system 10 includes a computer system having hardware and/or software components for communicating with the network 15 and the host system 20. The client system 10 and host system 20 each may include one or more computers systems and may be structured and arranged to communicate using various communication protocols to establish connections between network elements and/or to operate within or in concert with one or more other systems (e.g., the Internet and/or Web).

In one implementation, the client system 10 and the host system 20 each include one or more devices operating under the command of a controller (e.g., client controller 11, host controller 21). The broken lines are intended to indicate that in some implementations, the controller, or portions thereof considered collectively, may instruct one or more elements of the systems to operate as described. Accordingly, the functions described herein may be implemented as software controlling one or more elements of the client system 10 and/or the host system 20.

An example of a device is a general-purpose computer capable of responding to and executing instructions in a defined manner. Other examples include a special-purpose computer, a personal computer (PC), a workstation, a server, a laptop computer, a web-enabled telephone, a web-enabled personal digital assistant (PDA), a microprocessor, and integrated circuit, or any other component, machine, tool, equipment, or some combination thereof capable of responding to and executing instructions.

An example of a controller is a program or software application installed on one or more devices. Other examples include, codes, instruction sets, signals, or some combination thereof, for independently or collectively providing instructions. The controller may be implemented utilizing any suitable computer language and/or object-oriented techniques. The controller also may be a device (e.g., a workstation or PC, a microprocessor, a network server, a Java virtual machine, or an application-specific integrated circuit) and may be embodied permanently or temporarily in any type of machine, component, physical or virtual equipment, storage medium, or propagated signal capable of delivering instructions. In particular, the controller (e.g., computer program, software application) may be stored on a storage medium (e.g., disk, device, propagated signal), such that if the storage medium is read by a computer system, the functions described herein are performed.

The network 15 may include one or more delivery systems for directly or indirectly connecting the client system 10 and the host system 20. Examples of delivery systems include, but are not limited to, a local area network (LAN), a wide area network (WAN), the Internet, the Web, a telephone network, a radio network, a television network, a cable network, a satellite network, and/or any other wired or wireless communications network configured to carry data. Each network, in turn, may include elements, such as, for example, intermediate nodes, proxy servers, firewalls, routers, switches, adapters, sockets, and wired or wireless data pathways, configured to direct and/or deliver data.

In one embodiment, the host system 20 is configured to accurately track a high volume (e.g., 2 Million units per month) of serialized information. Examples of serialized information include, but are not limited to: an Electronic Serial Number (ESN), an International Mobile Equipment Identification (IMEI), a mobile identification number (MIN), an unlocking code for the handset, a Subscriber Information Module (SIM) card code, a serial number of a finished handset assembly, a serial number of a basic component (e.g., speakers, microphones, keypads, displays, ringers, processors, chipsets, memories, displays, batteries) or an add-on component (e.g., communication devices, cameras, location technologies, multimedia players) of a finished handset, immigration (e.g., visa) information, and/or hotel transaction (e.g., reservation, payment) information.

In one implementation, the host system 20 may be designed as a discreet entity tracking system for managing a high volume of serial numbers encountered when managing wireless handset products. The host system 20 may track the movement and status of items and communicate information to manufacturers, distributors, carriers, customers, operations and other company areas and partners. Other potential uses of this technology include, but are not limited to, tracking the “ins” and “outs” of persons entering and leaving a country (e.g., tracking visa information) and reconciling or clearing a high number of complex due-to/due-from situations that occur in the hotel industry.

As depicted in FIG. 1, the host system 20 contains three system layers: an Enterprise Resource Planning (ERP) system 22 (e.g., Solomon IV v4.21), a Serialized Inventory Control (SIC) system 23, and a Manufacturing system 24 (e.g., VAIK, ABC, SNDB). Typically, the systems will employ a common database platform (e.g., MS SQL Server 2000) with business logic residing in the appropriate modules. In general, the modules may be implemented as hardware and/or software for performing the operations described below. It is to be understood that while certain components of the host system 20 are shown as monolithic structures, each may include numerous elements (e.g., servers, routers, switches, firewalls, sockets, databases, tables, disks, hard drives, etc.) in various embodiments.

In general, the ERP system 22 may be configured to cover inventory quantity and cost information, while the SIC system 23 may be configured to maintain serialized information. The manufacturing system 24 may be configured to incorporate business rules and manage the operational steps of manufacturing (fulfillment) for a particular industry or technology. Controlling serialized information with SIC system 23 allows the ERP system 23 and the manufacturing system 24 to remain substantially independent.

In one embodiment, the SIC system 23 is linked or otherwise integrated with the ERP system 22 and the manufacturing system 24 (e.g., VAIK, ABC, SNDB). For example, the SIC 23 system may function as third tier software service integrating the ERP system 22 and manufacturing systems 24 to allow an infinitely scalable platform for managing the “ins” and “outs” of serial numbers or other discreet items. While the ERP system 22, the SIC system 23, and the manufacturing system 24 are tightly integrated, such systems still may be considered substantially independent in terms of process. That is, the interfaces between the systems are configured so as to complement and not interfere with the functionality of the others.

In one implementation, the SIC system 23 may include interfaces and/or tables for retrieving information from, moving information to, and/or processing information of the ERP system 22 and the manufacturing system 24. The SIC system 23 may maintain a perpetual history for all receipt and disbursements transactions for both physical and virtual inventory items. The SIC system 23 also may track site and location data and other costing information as directed by business need. The SIC system 23 may employ referential integrity constraints at the database level in order to handle high transaction volumes. The SIC 23 may maintain a sum of serialized numbers corresponding to the balances of stock items covered by the ERP system 22. The serial number records managed by the SIC system 23 may provide detail supporting the inventory quantity and costs in the ERP system 23.

In one implementation, the ERP system 22 initiates and drives the operational processes involving the financial cycle (i.e. General Ledger, Accounts Receivables, Accounts Payable, Cash Manager) and the distribution cycle (i.e. Sales, Inventory) of inventory items. Examples of transactions that may be covered by the ERP system 22 include, but are not limited to: Purchase Order (PO) Receipts, PO Returns, Inventory Receipts, Manufacturing (fulfillment), Transfers, Activations, Adjustments, Sales, and/or Sales Returns (RFC).

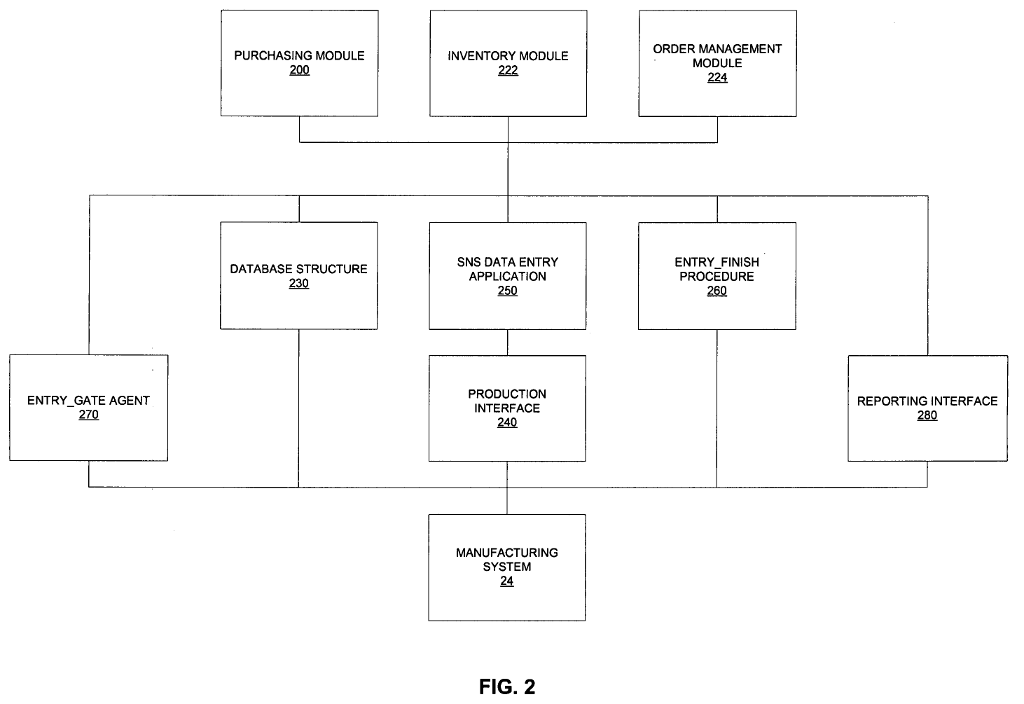

In order to support such transactions, the ERP system 22 may transfer inventory information (e.g., purchasing data, cost data, payables data, sales data, receivables data, and/or balance data) to one or more financial modules. Referring to FIG. 2, one embodiment of the ERP system 22 includes a plurality of financial modules including a purchasing module 220, an inventory module 222, and an order management module 224.

The purchasing module 220 may be configured to cover purchase order receipts and returns. In this embodiment, the purchasing module 220 allows a user to generate a purchase order, enter purchase order receipt, and enter purchase order returns. A purchase order may have data fields including, for example: Item ID, contract Qty, Landed Cost, Vendor, and Arranged Date. For existing purchase orders and purchase order receipts, a user can enter a negative PO receipt in the purchasing module 220 to indicate a purchase order return. The purchasing module 220 also may allow a user to update and save data.

The inventory module 222 may be configured to cover inventory receipt, inventory transfer, inventory activation, and inventory adjustments. In this embodiment, the inventory module 222 is responsible for maintaining the cost, location and quantity status (e.g., Qty On PO, Qty in Production, Inactivated, Damage and Available for Sale) of inventory items. The inventory module 222 may allow a user to adjust inventory (e.g., by batch) by populating data fields including, for example: Item Id, quantity (with +/−sign to indicate adjustment), cost (with +/−sign to indicate adjustment), site, bin location and date. The inventory module 222 also may allow a user to transfer inventory by populating data fields including, for example: Item Id, quantity, FROM and TO information (site and bin) and date. To activate inventory, i.e. transfer an inventory batch from an inactivated bin to an activated bin, the inventory module 222 may display a screen allowing a user to identify the site and the location of the inactive bin and then automatically define an active bin.

The order management module 224 may be configured to cover manufacturing (fulfillment) processes as well as sales and sales returns. In this embodiment, the order management module 224 allows a user to create and update a work order. The data fields of a work order may include, for example: good, planned quantity to be produced, date, and site (carrier). The order management module 224 may display a screen corresponding to a particular shipper that allows a user to print a work order, register a work order with a manufacturing module, confirm the movement of inventory from a warehouse to a production area, and/or verify inventory location (e.g., bin). The order management module 224 also may allow a user to create a sales order and/or a sales return by populating data fields including, for example: Items, planned quantity to ship, date, site, and bin location.

In one implementation, the SIC system 23 maintains serialized information for transactions involving the entry of items into and the exit of items from a system. The SIC system 23 monitors in-transactions and out-transactions and tracks the net balance of stock within the system. Records are created and updated as items enter and exit from the system on a near real time basis. The SIC system 23 includes logic to check that that serialized information does not exist for an inventory item that is just entering the system and that serialized information does exist for an inventory item that is exiting the system. The SIC system 23 provides real time auditing and exception monitoring for components as well as finished goods.

Referring to FIG. 2, one embodiment of the SIC system 23 includes a database structure 230, production interface 240, a Serial Number System (SNS) Data Entry Application 250, an ENTRY_FINISH procedure 260, an ENTRY_GATE agent 270, and a reporting interface 280. In general, the database structure 230 may be configured to store values pertaining to serial number transactions. The production interface 240 may be configured for to integrate with and manage information from a manufacturing system 24. The SNS Data Entry Application 250 may be configured for allowing a user to register serial number data in various ways. The ENTRY_FINISH procedure 260 may be configured to update and/or check the integrity of registered serialized information (e.g., for a given inventory batch or shipper in ERP system 22). The ENTRY_GATE agent 270 may be configured to search for available records in the database structure 230 and the ERP system 22. The reporting interface 280 may be configured for creating and modifying reports.

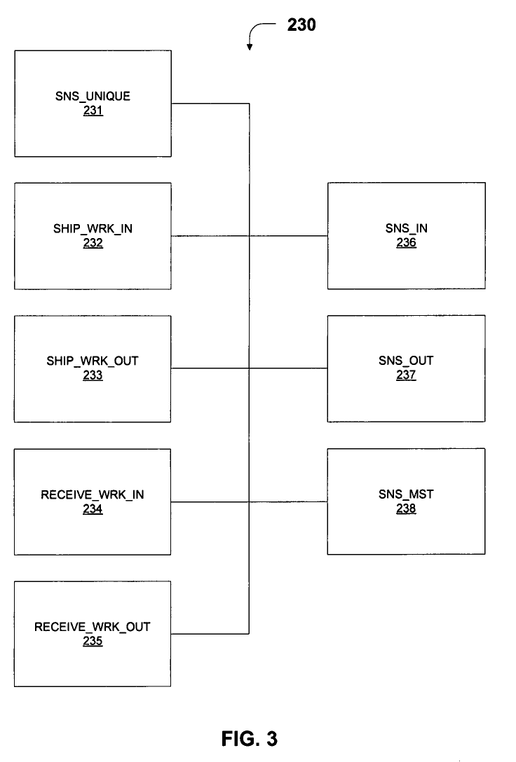

FIG. 3 illustrates one embodiment of a database structure 230 includes a SNS_Unique table 231, a SHIP_Wrk_IN table 232, a SHIP_Wrk_OUT table 233, a RECEIVE_Wrk_IN table 234, a RECEIVE_Wrk_OUT table 235, a SNS_IN table 236, a SNS_OUT table 237, and a SNS_MST table 238.

The SNS_Unique table 231 may be configured to ensure that there are not two of the same items being scanned and returned at the same time.

The SHIP_Wrk_IN table 232 may be configured to save values for serial number transactions. In this embodiment, the SHIP_Wrk_IN 232 table may save the values of each serial number transaction, including: batch number, module, type, line number, item, serial number, sign and status. The SHIP_Wrk_IN table 232 may save the positive data entries (e.g., new Serial Numbers) from the Data Entry Application 250 and/or the production applications interface 240. The SHIP_Wrk_IN table 232 may save such values, before they are moved to the SNS_IN table 236 by the SNS_ENTRY_GATE agent 270, when the appropriate conditions are fulfilled.

The SHIP_Wrk_OUT table 233 may be configured to save values for serial number transactions. In this embodiment, the SHIP_Wrk_OUT table 233 may save the values of each serial number transaction, including: batch number, module, type, line number, item, serial number, sign and status. The SHIP_Wrk_OUT table 233 may save negative data entries (e.g., disposed Serial Numbers) from the Data Entry Application 250 and/or the production applications interface 240. The SHIP_Wrk_OUT table 233 may save such values, before they are moved to the SNS_OUT table 237 by the SNS_ENTRY_GATE agent 270, when the appropriate conditions are fulfilled.

The RECEIVE_Wrk_IN table 234 may be configured to save values for serial number transactions. In this embodiment, the RECEIVE_Wrk_IN table 234 may save the values of each serial number transaction, including: batch number, Module, Type, Line Number, Item, Serial Number, sign and Status. The RECEIVE_Wrk_IN table 234 may save positive data entries (e.g., new Serial Numbers) from the SNS Data Entry Application 250 and/or the production applications interface 240. The RECEIVE_Wrk_IN table 234 may save such values before they are moved to the SNS_IN table 236 by the SNS_ENTRY_GATE agent 270, when the appropriate conditions are fulfilled.

The RECEIVE_Wrk_OUT table 235 may be configured to save values for serial number transactions. In this embodiment, the RECEIVE_Wrk_OUT table 235 may save the values of each serial number transaction, including: Batch Number, Module, Type, Line Number, Item, Serial Number, sign and Status. The RECEIVE_Wrk_OUT table 235 may save negative data entries (e.g., disposed Serial Numbers) from the SNS Data Entry Application 250 and the production applications interface 240. The RECEIVE_Wrk_OUT table 235 may save such values, before they are moved to the SNS_OUT table 237, by the SNS_ENTRY_GATE agent 270, when the appropriate conditions are fulfilled.

The SNS_IN table 236 may be configured to save values for serial number transactions. In this embodiment, the SNS_IN table 236 is a transactional table that saves values for positive transactions (e.g., new Serial Numbers) moved from the SHIP_Wrk_IN table 232 and/or the RECEIVE_Wrk_IN table 234 by the SNS_ENTRY_GATE Agent 270 when the appropriate conditions are fulfilled. The table structure may be based on and maintain values from a transactional table (e.g., LotSerT transactional table) in the ERP system 22. The SNS_IN table 236 may save referential data. The referential data may link the SNS_IN table 236 to the SNS_OUT table 237 for tracking the disposition or movement of an inventory item.

The SNS_OUT table 237 may be configured to save values for serial number transactions. In this embodiment, the SNS_OUT table 237 is a transactional table that saves the negative transaction (e.g., disposed Serial Numbers) moved from the SHIP_Wrk_OUT table 233 and/or the RECEIVE_Wrk_OUT table 235 by the SNS_ENTRY_GATE Agent 270 when the appropriate conditions are fulfilled. The table structure may be based on and maintain values from a transactional table (e.g., LotSerT transactional table) in the ERP system 22. The SNS_OUT table 237 may save referential data. The referential data may link the SNS_IN table 236 to the SNS_OUT table 237 for tracking the disposition or movement of an inventory item.

The SNS_MST table 238 may be configured to save values for serial number transactions. In this embodiment, the SNS_MST table 238 may save serial numbers scanned or otherwise input into the system. The SNS_MST may save actual and previous (e.g., historical table) serial numbers for items that are part of the inventory at a given point of time. In one implementation, the SNS_MST table 238 may be used to validate the existence of serialized information. The table structure may be based on and maintain values from a transactional table (e.g., LotSerMST table) in the ERP system 22.

Referring again to FIG. 2, one embodiment of the SIC system 23 includes a production interface 240 for integrating with a manufacturing system 24. In general, the production interface 240 may be configured to perform one or more processes related to the operational steps of manufacturing (fulfillment).

The production interface 240 may perform a work order start check process. For example, a work order (WO) may not begin production on the warehouse floor without first having been created and activated in the ERP system 22. In one implementation, the manufacturing system 24 may use the production interface 240 to ensure WO availability.

The production interface 240 may perform a serial number validation process. For example, the manufacturing system 24 may use the production interface 240 to check and validate serial number existence in the SIC system 23 (e.g., SNS_MST table 238). In implementation, functionality of the manufacturing system 24 may be suspended if errors are found until a supervisor overrides the error check and allows production to continue.

The production interface 240 may include a production output process. For example, instead of exporting data to carrier operators at the end of a production run, the manufacturing system 24 may save production output data in a SNS worktable. The production output data may include the following information: serial numbers of items disposed (e.g., components) and the serial number for the final product (e.g., pack), and the date of production.

The production interface 240 may perform a kit definitions process. For example, the manufacturing system 24 may need to be flexible enough to work with several kit definitions (e.g., components required to assembly a finished pack). In one implementation, the kit definitions may be maintained on one system (e.g., the ERP system 22) and shared by the other systems (e.g., SIC system 23 and manufacturing system 24).

Referring again to FIG. 2, one embodiment of the SIC system 23 includes a SNS Data_Entry Application 250. In general, the SNS_Data_Entry application 250 may be configured for allowing a user to register serial number data in various ways. For example, the SNS_Data_Entry application 250 may register serial numbers that are manually entered and/or manual scanned. The SNS_Data Entry application 250 also may register serialized information by importing files (e.g., .csv files) or by receiving a work order number or group number (e.g., master box ID) and then automatically populating the corresponding serial numbers.

In one implementation, the SNS_Data_Entry application 250 may include a user interface (e.g., Visual Basic screen) for registering serialized information. In general, the SNS_Data_Entry application 250 may be developed using modular development rules and designed to be fault tolerant.

In one embodiment, the SNS_Data_Entry application 250 includes a header/detail (grid) screen. The header portion of the screen may capture the identification of the information to be registered. The header may include data fields such as, for example: type of transaction or inventory process requiring serial number identification (e.g., Receipt, Purchase Return, Kit Assembly, Transfer, Activation, Adjustment, Sale or Sale Return), batch number, line number, inventory item, quantity of serial numbers required to be entered, site ID, and location ID. The inventory item, quantity, site ID, and location ID fields may be referential fields filled after the line number selection. The detail portion of the screen may include a grid for registering the serial numbers. In some embodiments, the screen allows entering only as many items as defined by the quantity for the selected line number. In one implementation, the grid includes the following fields: item number, serial number, and master box (at reception) for allowing users to group serial numbers.

The SNS_Data_Entry application 250 generally should support data selection for the header fields, based on the previous selected fields. In some implementations, the screen may only accept to register serial numbers for valid Batches and/or shippers in the appropriate status, as defined in the process rules.

In one implementation, the SNS_Data_Entry application 250 is configured to apply validation rules to entered data. The validation rules may include a mask requiring all serialized information to meet certain data field definitions for data type (e.g. numerical, hexadecimal) and length. The validation rules also may require non-duplicates. For example, when new items are registered (e.g., receptions, production—finish items, positive adjustments, sales returns) the SNS_Data_Entry application 250 may check that the serial numbers do not exist as available in the SNS_MST table 238. The validation rules also may require existence. For example, when items are disposed (e.g., Purchase Returns, Production—components, negative adjustments, Sales) the SNS_Data_Entry application 250 may check that those serial numbers exist as available in the SNS_MST table 238.

In one embodiment, the SNS_Data_Entry application 250 saves data in working tables (e.g., SNS_Wrk_IN table 232, SNS_Wrk_OUT table 233) according to the transaction sign. The SNS_Data_Entry application 250 may require user confirmation before saving the data in the working tables. When the last line number of a specified batch or shipper has been entered (and confirmed), the SNS_Data_Entry application 250 triggers the SNS_ENTRY_FINISH procedure 260.

As shown in FIG. 2, one embodiment of the SIC system 23 includes a SNS Entry_Finish procedure 260. In general, the ENTRY_FINISH procedure 260 may be configured to update and/or check the integrity of registered serialized information for a given inventory batch or shipper in ERP system 22, for example.

In one implementation, the SNS Entry_Finish procedure 260 may be triggered by the SNS Data_Entry Application 250 or a manufacturing module after serialized information is registered for a given batch or shipper. When triggered by the SNS Data_Entry Application 250 (e.g., Receipts, Purchase Returns, Transfers, Activations, Adjustments, Sales and Sales Returns), the SNS Entry_Finish procedure 260 may update the batch status to “Balanced” (ready to release) if the transaction is originated by the purchasing module 220 or the inventory module 222 or may change the shipper stage to the last one (e.g., ready to be taken by the OM sales journal) if the transaction is originated by the order management module 224.

When triggered from a manufacturing module, the SNS Entry_Finish procedure 260 may perform an integrity review task. The integrity review task may check for inexistent serial number components and for duplicate serial number components. In cases where an inexistent serial number is detected, a record is inserted in the SNS_IN table 236 and flagged in the SNS_MST table 238 in order to allow the process to follow. In cases where a duplicate serial number is detected, the record in the SNS_MST table 238 is flagged as an error. After the integrity review task is performed, the SNS Entry_Finish procedure 260 may change the OM shipper stage to the last one (e.g., ready to be taken by the OM sales journal) if no duplicate serial number conditions or finished goods appear for the manufacturing order.

As shown in FIG. 2, one embodiment of the SIC system 23 includes a SNS Entry_Gate SQL Agent 270. In general, the ENTRY_GATE agent 270 may be configured to search for available records in the database structure 230 and/or in the ERP system 22. In one implementation, the SNS Entry_Gate 270 periodically (e.g., every “n” minutes) may search working tables (e.g., SHIP_Wrk_IN table 232, SHIP_Wrk_OUT table 233, RECEIVE_Wrk_IN table 234, RECEIVE_Wrk_OUT table 235) for available (existing) records and corresponding batch numbers in the ERP system 22.

Once the ERP batch is released, for example, OM where the batch is created and auto released by the OM sales journal, the SNS Entry_Gate agent 270 may proceed to insert transactions in the transactional tables (e.g., SNS_IN table 236, SNS_OUT table 237) and erase transactions from the working tables (e.g., SHIP_Wrk_IN table 232, a SHIP_Wrk_OUT table 233, a RECEIVE_Wrk_IN table 234, a RECEIVE_Wrk_OUT table 235).

In some implementations, the SNS Entry_Gate agent 270 also may need to update the other tables depending on the transaction. For example, in case of a new SNS_IN transaction, the SNS Entry_Gate agent 270 may be required to update the SNS_MST table 238 in order to register the available serial number item. In case of a new SNS_OUT transaction, the SNS Entry_Gate agent 270 may be required to update the SNS_MST table 238 in order to delete the serial number item and move it to an historical table as a disposed item. The SNS Entry_Gate agent 270 also may update the SNS_IN table 236 in order to register the relation of the record in the SNS_IN table 236 with the record in the SNS_OUT table 237 that disposes of the item.

For manufacturing transactions, the SNS Entry_Gate agent 270 may be required to save the serial number of the finished good in the SNS_OUT table 237 for the item components in order to maintain the information of how/when an item was used and what components were use to build a particular finish good. For Transfer/Activation transactions, the site and bin location fields in the SNS_IN table 236 and in the SNS_MST 238 table may be updated.

As shown in FIG. 2, one embodiment of the SIC system 23 includes a reporting interface 280. In general, the reporting interface 280 may be configured for generating and/or modifying reports. In one embodiment, reports are generated from the SNS_IN table 236, the SNS_OUT table 237, and the SNS_MST table 238. The reports may include an inexistent serial number report identifying the SNS_IN lines that needed to be inserted in order to solve the usage of non-existing serial numbers for components of a production order. The reports also may include a duplicate serial number report identifying the SNS_MST records flagged as an error when a production order attempts to generate new goods with already in use serial numbers.

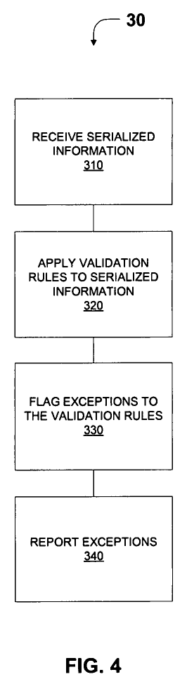

Referring to FIG. 4, a communications system operates according to a procedure 30 for accurately tracking a high volume of serialized information. The procedure 30 generally may involve receiving serialized information (step 310), applying validation rules to the serialized information (step 320), flagging exceptions to the validation rules (step 330), and reporting the exceptions (step 360). While particular embodiments and examples are described and illustrated, the procedure 30 may be implemented by any suitable type of hardware (e.g., device, computer, computer system, equipment, component), software (e.g., program, application, instruction set, code), storage medium (e.g., disk, device, propagated signal), or combination thereof.

At step 310, serialized information is received. In one embodiment, the SIC system 23 receives and maintains serialized information for transactions involving the entry of items into and the exit of items from a system. The SIC system 23 monitors in-transactions and out-transactions and tracks the net balance of stock within the system. Records are created and updated as items enter and exit from the system on a near real time basis.

In one implementation, the process for receiving serialized information is initiated by an ERP system 22 and/or a production module. The ERP system 22 may allow a user to create a purchase order, enter purchase order receipt, enter purchase order returns, enter inventory receipt, transfer inventory transfer, activate inventory, adjust inventory, create work orders, update work orders, monitor work orders, enter sales, and enter returns. After entering data in the ERP system 22, a user will may be prompted to scan or otherwise input serial information involved in the ERP process into the SIC system 23. For instance, the user may could select from “not already filled lines” to enter a block using the data entry capabilities (e.g., manual scan, file, etc.).

The user may enter serialized information including, for example: inventory IDs and serial numbers register the purchase order receipt, enter a batch number for inventory transfer, inventory activation, inventory adjustment, register the OM shipper number.

Serialized information may be saved in the appropriate working tables (e.g., SNS_Wrk_IN table 232 for receipts, SNS_Wrk_OUT 232 for returns). The production of final goods may be SNS_Wrk_IN table 232) for the final goods and SNS_Wrk_Out 233 for the disposed components, according to the provided format. The tables may include data fields: batch number, module, type, line number, item, serial number, sign (+/−for receipt/returns, status, production reference ID (for manufacturing), planned quantity to ship, date, site location, and/or bin location.

At step 320, validation rules are applied to the serialized information. In one embodiment, the SIC system 23 includes logic to check that that serialized information does not exist for an item that is just entering the system and that serialized information does exist for an inventory item that is exiting the system.

In one implementation, the SNS_Data_Entry application 250 is configured to apply validation rules to entered data at the database level. The validation rules may include a mask requiring all serialized information to meet certain data field definitions for data type (e.g. numerical, hexadecimal) and length. The validation rules also may require non-duplicates. For example, when new items are registered (e.g., receptions, production—finish items, positive adjustments, sales returns) the SNS_Data_Entry application 250 may check that the serial numbers do not exist as available in the SNS_MST table 238. The validation rules also may require existence. For example, when items are disposed (e.g., Purchase Returns, Production—components, negative adjustments, Sales) the SNS_Data_Entry application 250 may check that those serial numbers exist as available in the SNS_MST table 238.

The SNS_Data_Entry application 250 may check for valid serial numbers (mask) and valid numbers (existing with no duplicates) during the data entry process and before allowing saving the entry. The SNS_Data_Entry application 250 also check that a line item or batch exists and is not already received.

In some implementations, after the last of the serialized information has been registered, the SNS_ENTRY_FINSH procedure 260 may be triggered to update the ERP system 22. The SNS_Entry_Finish procedure 260 may update, for example, purchase order (receipt/return batch) status, inventory (transfer/activate/adjust batch) status, step status of the OM Shipper to the following step that will make it eligible for the OM Sales Journal Process.

The production interface 240 may perform a serial number validation process. For example, the manufacturing system 24 may use the production interface 240 to check and validate serial number existence in the SIC system 23 (e.g., SNS_MST table 238). In implementation, functionality of the manufacturing system 24 may be suspended if errors are found until a supervisor overrides the error check and allows production to continue.

In some implementations, before proceeding with the ERP update, the SNS_ENTRY_FINSH procedure 260 may perform data checks and updates for assembly transactions. Once the batch (e.g., purchase order receipt batch, purchase order return batch, inventory kit batch, inventory transfer batch, inventory activate batch, inventory adjust batch, sales batch, returns batch) is released, the SNS_ENTRY_GATE 270 agent checking for available records in the SNS_Wrk_IN/SNS_Wrk_OUT tables will proceed to move the transactions records to the SNS_IN/SNS_OUT tables and to update the SNS_MST (and SNS_IN for the case of returns) table accordingly.

The SNS_ENTRY_GATE agent 270 checking for available records in the SNS_Wrk_IN/SNS_Wrk_OUT tables will proceed to move the transactions records to the SNS_IN/SNS_OUT tables and to update the SNS_MST (and SNS_IN for the case of returns) table accordingly. For inventory transfer transactions, the SNS_ENTRY_GATE agent 270 may update the site and bin location fields in the SNS_IN table 236 and SNS_MST table 238 when it finds pending transfer records in the SNS_Wrk_IN table 232 that are related to an already released inventory transfer batch.

At step 330, exceptions to the validation rules are flagged. In cases where an inexistent serial number is detected, a record is inserted in the SNS_IN table 236 and flagged in the SNS_MST table 238 in order to allow the process to follow. In cases where a duplicate serial number is detected, the record in the SNS_MST table 238 is flagged as an error. The SNS_ENTRY_FINSH procedure 260 may insert and mark SNS_IN/SNS_MST records for component serial Numbers “disposed” for a manufacturing process that does not exist in the SNS tables. The SNS_ENTRY_FINSH procedure 260 may mark SNS_MST records as “errors” in cases where the finished good (e.g., kit assembly) serial number already exists and is available in the SNS tables.

At step 340, exceptions are reported. In one embodiment, the SIC system 23 provides real time auditing and exception monitoring for components as well as finished goods. In one embodiment, reports are generated from the SNS_IN table 236, the SNS_OUT table 237, and the SNS_MST table 238. The reports may include an inexistent serial number report identifying the SNS_IN lines that needed to be inserted in order to solve the usage of non-existing serial numbers for components of a production order. The reports also may include a duplicate serial number report identifying the SNS_MST records flagged as an error when a production order attempts to generate new goods with already in use serial numbers.

As described and illustrated, aspects of the present invention allow accurately tracking a high volume of serialized information. A number of implementations have been described. Nevertheless, it will be understood that various modifications may be made and that other implementations are within the scope of the following claims.

1. A communications system comprising:
a host system in communication with one or more client systems, the host system having a serialized inventory control system configured to:
receive serialized information;
apply validation rules to the serialized information;
flag exceptions to the validation rules; and
report the exceptions,
wherein the serialized inventory control system includes database logic to check that that serialized information does not exist for an entering inventory item and that serialized information does exist for an exiting inventory item.

2. The communications system of claim 1, wherein the serialized information comprises an electronic serial number.

3. The communications system of claim 2, wherein the electronic serial number is associated with a finished good.

4. The communications system of claim 3, wherein the finished good comprises a handset.

5. The communications system of claim 2, wherein the electronic serial number is associated with a component of a finished good.

6. The communications system of claim 1, wherein the serialized information comprises immigration data.

7. The communications system of claim 1, wherein the host system further comprises an enterprise resource planning system.

8. The communications system of claim 2, wherein the enterprise resource planning system comprises a purchasing module configured to cover purchase receipts and returns.

9. The communications system of claim 2, wherein the enterprise resource planning system comprises an inventory module configured to cover inventory receipt, inventory transfer, inventory activation, and inventory adjustments.

10. The communications system of claim 2, wherein the enterprise resource planning system comprises an order management module configured to cover manufacturing processes, sales transactions, and sales returns transactions.

11. The communications system of claim 1, wherein the host system further comprises a manufacturing system.

12. The communications system of claim 1, wherein the serialized inventory control system comprises a database structure configured to store values pertaining to serial number transactions.

13. The communications system of claim 12, wherein the serialized inventory control system further comprises a serial number data entry application configured for allowing a user to register serialized information.

14. The communications system of claim 12, wherein the serialized inventory control system comprises a procedure configured to update and check integrity of the serialized information.

15. The communications system of claim 12, wherein the serialized inventory control system comprises a procedure for updating and checking integrity of the serialized information.

16. The communications system of claim 12, wherein the serialized inventory control system comprises an reporting interface for creating and modifying reports.

17. A method of inventory control capable of being performed by a computer system, the method comprising the steps of:
receiving serialized data;
applying validation rules to the serialized data;
flagging exceptions to the validation rules; and
reporting the exceptions,
wherein the validation rules comprise database logic to check that that serialized data does not exist for an entering inventory item and that serialized data does exist for an exiting inventory item.

18. The method of claim 17, wherein the computer system comprises at least one of a host system and a client system.

19. A computer program stored on a computer-readable medium, the computer program comprising instructions to:
receive serialized information;
apply validation rules to the serialized information;
flag exceptions to the validation rules; and
report the exceptions.

20. The computer program of claim 19, wherein the computer-readable medium comprises at least one of a client device, a network device, a host device, a disk, and a propagated signal.
